(19) United States
(12) Patent Application Publication
(10) Pub. No.: US 2015/0096774 A1
(43) Pub. Date: Apr. 9, 2015

(54) Carbon Steel Cultipacker Wheel

(71) Applicant: Shawn Lamar Edwards, Savannah, TN (US)

(72) Inventor: Shawn Lamar Edwards, Savannah, TN (US)

(21) Appl. No.: 14/046,944

(22) Filed: Oct. 5, 2013

(51) Int. Cl. A01B 29/02; A01B 76/00

(52) U.S. Cl. CPC A01B 29/02; A01B 76/00
USPC 172/747

(57) ABSTRACT

I being, in the business of farm implement and tractor repair, have come to realize that sometimes repairing old equipment is difficult and more costly than just replacing with a new part or a complete implement. I found this particularly true with the cultipacker, after having several customers ask for repairs on old ones and having problems repairing them due to lack of reliable wheels. I decided to see if I could come up with a product to solve the problem. After about five years of research, trial and error I finally came up with what I consider an excellent solution to the problem The Carbon Steel Cultipacker Wheel. Since my invention of the wheel I have sold many steel wheel cultipackers and have happy customers.

### BACKGROUND OF INVENTION

I decided to build the Carbon Steel Wheel Cultipacker, when I saw the need for the Carbon Steel Wheel from first hand knowledge of dealing with and rebuilding the old cast iron cultipackers. The cast iron wheels would break and didn't last very long, after several years of rebuilding and searching for cast iron wheels so I could repair cultipackers for my customers. I decided to see if I could produce a more reliable wheel. After more than a year I have accomplished my goal. My customers have been very pleased with the carbon steel wheels, they do as good a job if not better than cast iron and they are more efficient and reliable.

The endeavor of the Carbon Steel Cultipacker Wheel is to provide a much better product for farmers and hunters who sow seeds. In the past the most common choice was the cast iron wheel. Which are very brittle, wear easily, and easily break, once broken, they are expensive to repair, and very few welding shops can repair them, because it takes a specific welding machine to weld them. Also very few welders have the expertise to weld them. To say the least it is cheaper and easier to replace the wheels if you can find replacement wheels. Replacement wheels are very hard to find. If you do find them they very expensive.

### SUMMARY OF THE INVENTION

My invention of the Carbon Steel Cultipacker Wheel will change the Cultipacker industry forever. With The Carbon Steel Cultipacker Wheel you can have an efficient reliable product that can easily be repaired. For example you can hit a cast iron wheel with a small 2 pound hammer and it will break with one swing. You can take my carbon steel cultipacker wheel and beat on it 50 swings with a 10 pound sledge hammer and you will not even put a dent it, let alone break it or damage it in anyway. Also anyone with any kind of welder such as a Lincoln stick welder, or a Mig Welder, even with minimal welding skills can repair our wheels, because they are made from carbon steel. Also they are much, much, more durable. They can be repaired as many times as needed, however they will not need much welding due to the strength and durability of carbon steel.

### BRIEF DESCRIPTION OF SEVERAL VIEWS OF THE DRAWING

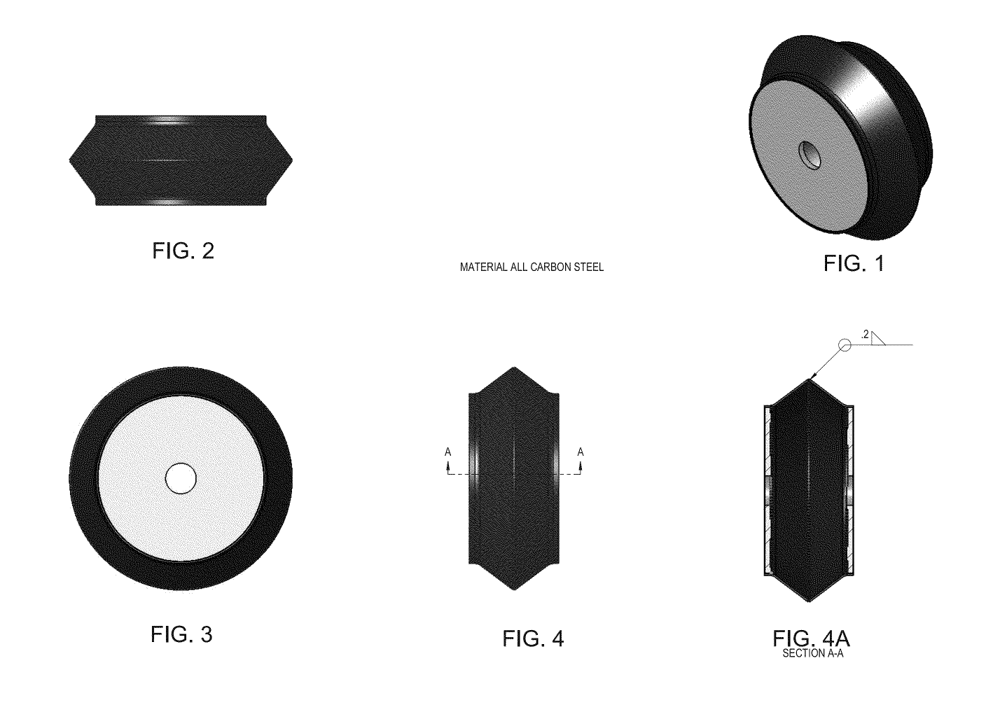

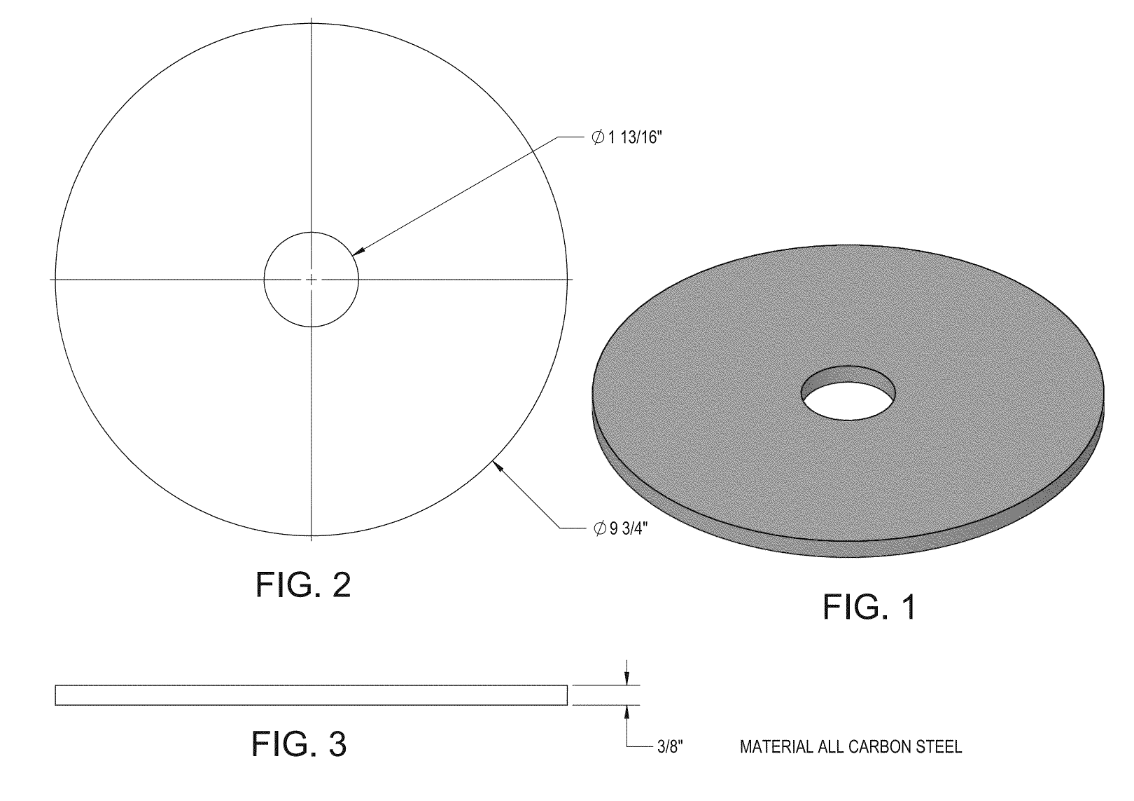

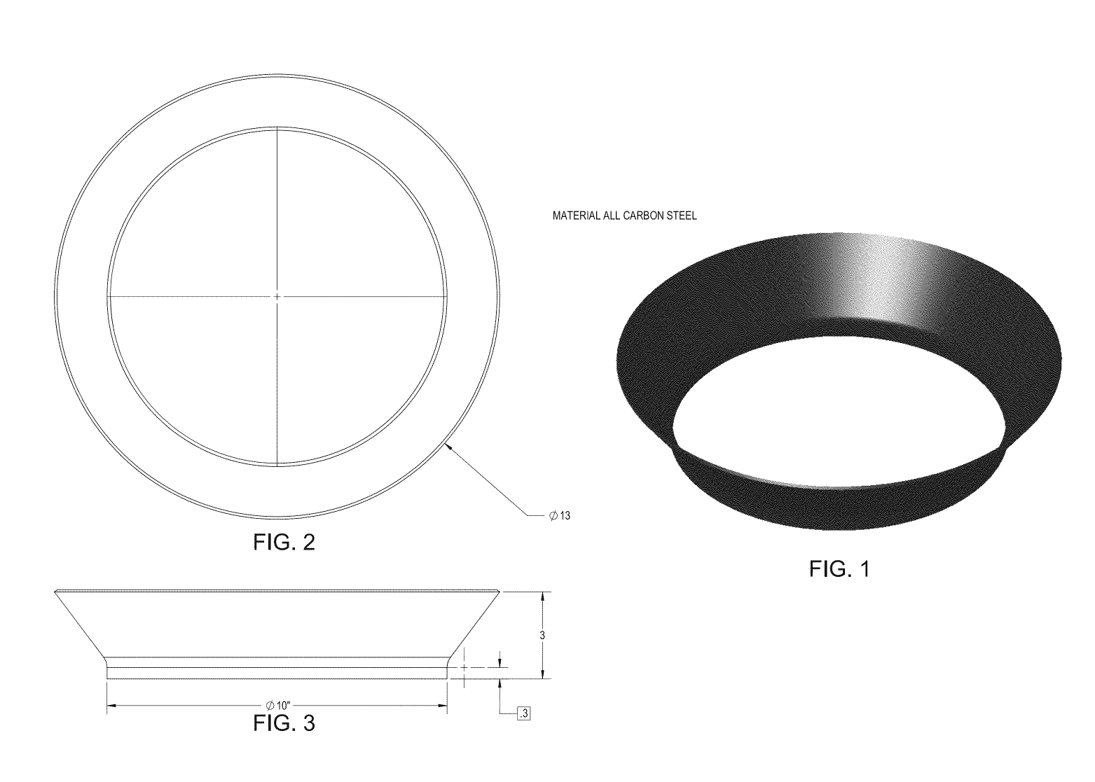

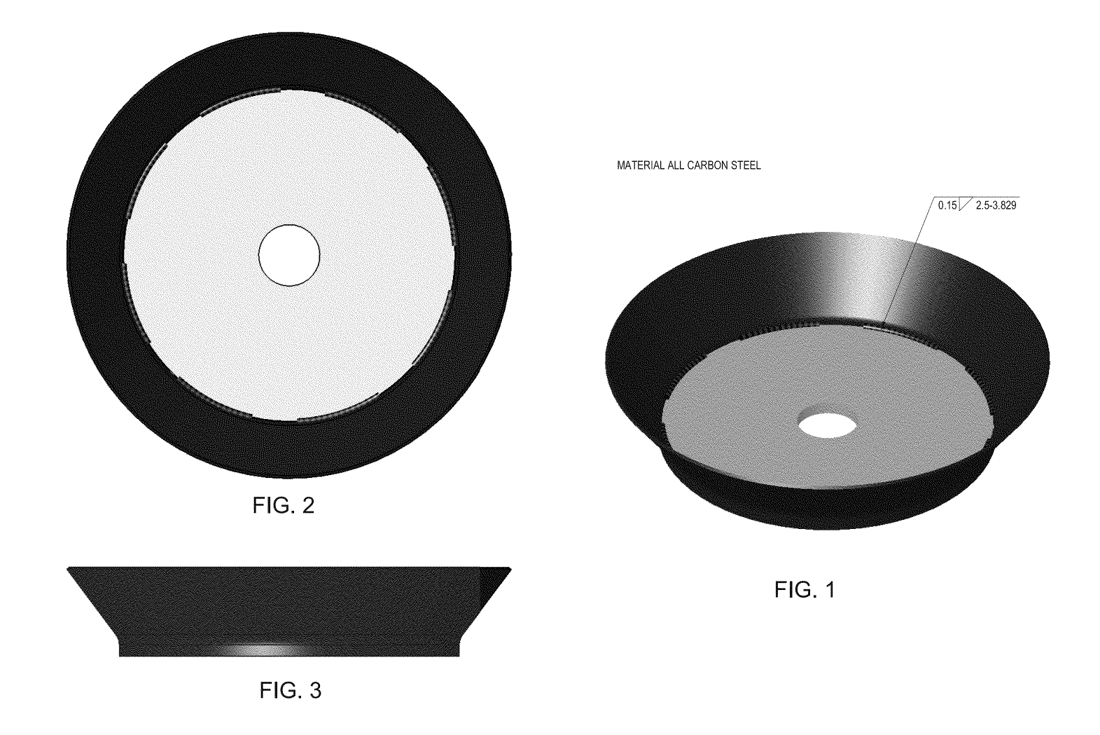

1/4 FIG. 1, FIG. 2, FIG. 3, FIG. 4, and FIG. 4a different views of a full carbon steel cultipacker wheel

4/4 FIG. 1, FIG. 2, FIG. 3 views of a carbon steel cultipacker wheel hub. The hub is the steel center piece of the wheel.

3/4 FIG. 1, FIG. 2, and FIG. 3, are all views of the carbon steel ring, the pieces that are welded together with the hub to make the carbon steel wheel.

2/4 FIG. 1, FIG. 2, FIG. 3, is all views of one half of the carbon steel cultipacker wheel, when welded together form an entire wheel.

### DETAILED DESCRIPTION OF THE CARBON STEEL CULTIPACKER WHEEL

We begin the process of building the steel wheel by cutting a piece of pipe that is 10 inches in diameter, with a wall thickness of 0.109. We cut it in lengths that are two and fifteen sixteenth inches long that gives us the form of half the wheel. We then use a press with a dye that we machined that gives us the shape of half of the wheel. It takes two of these pieces to make the wheel. We call this the wheel ring. We then take a piece of carbon steel three eighth inches thick that is nine and three fourth inches in diameter and has a one and three fourth inch hole in the center. This piece is called a hub. We insert the hub into the small end of the wheel ring it is then welded from the inside, making half of the carbon steel wheel. We repeat the process to make the other half of the wheel. We then align the wheel on a shaft that is one and three fourth inches in diameter. Then we tack weld it in three to five places after checking for proper alignment we place the wheel on a shaft that is attached to a table in a horizontal position and weld the halves together making a carbon steel cultipacker wheel.

1. My claim is the Carbon Steel Cultipacker Wheel, a wheel made out of carbon steel for a cultipacker.
